(19) United States
(12) Patent Application Publication
(10) Pub. No.: US 2022/0395017 A1
(43) Pub. Date: Dec. 15, 2022

(54) COMPOSITE AEROSOL-GENERATING MATERIAL

(71) Applicant: PHILIP MORRIS PRODUCTS S.A., Neuchatel (CH)

(72) Inventor: Fabio CANTIERI, Bologna (IT)

(21) Appl. No.: 17/762,797

(22) PCT Filed: Sep. 16, 2020
(86) PCT No.: PCT/EP2020/075903

§ 371 Date: Mar. 23, 2022

(30) Foreign Application Priority Data
Sep. 24, 2019 (EP) 19199287.4

(51) Int. Cl. A24C 5/18

(52) U.S. Cl. CPC A24C 5/1892

(57) ABSTRACT

A composite aerosol-generating material (530) comprising two sheets of carrier material (522A, 522B), with gel (544) interposed between. The method of manufacturing and apparatus for such manufacturing; a composite aerosol-generating material (530) comprising gel (544) interposed between two sheets of carrier material (522A, 522B). The gel (544) may carry an aerosol-generating substance, such as, nicotine.

The present disclosure relates to a composite aerosol-generating material, methods of manufacturing such composite aerosol-generating materials and apparatuses for such manufacture. In addition, the present disclosure relates to aerosol-generating rods comprising the composite aerosol-generating material, manufacturing methods to make such rods, and apparatuses to make such rods. The aerosol-generating rod may be for use in an aerosol-generating article. The aerosol-generating article may be for use with an aerosol-generating device. The present disclosure relates, in particular, but not exclusively, to an application of a gel in a sandwich configuration between aerosol-generating material, or carrier material. Preferably the gel comprises an active agent, for example flavours, humectants, plasticisers, or nicotine. Preferably the gel comprises a combination of active agents.

To manufacture the aerosol-generating rod, a procedure typically involves the following steps. A flat sheet of aerosol-generating material is unwound from a bobbin of aerosol-generating material. The aerosol-generating material is then typically sprayed with liquid or powder components such as glycerine or flavours. Finally, the aerosol-generating material is pulled through a funnel shaped device which gathers the sheet into a continuous cylindrical rod of the desired diameter. The continuous rod is wrapped and cut to a desired length before being combined with other rods in a line to form the aerosol-generating article.

However, spraying liquid or powder components onto the sheet may lead to certain drawbacks. For example, with the spraying process, typically only a portion of the material that is sprayed and fixed onto the sheet of aerosol-generating material.

It would therefore be desirable to provide an improved application of flavours and other components, which overcome these disadvantages. It would also be desirable to provide an aerosol-generating material for use in an aerosol-generating rod, and to provide an apparatus and a method of manufacturing the aerosol-generating material which would reduce the amount of wasted components, so that manufacturing costs can also be reduced and would require less cleaning thus saving time.

According to an aspect of the present invention there is provided a method of manufacturing a composite aerosol-generating material, comprising the steps of:
providing a first continuous sheet of carrier material;
dispensing gel to a surface of the first continuous sheet of carrier material;

providing a second continuous sheet of carrier material and positioning the second continuous sheet of carrier material to the gel to form a composite material with gel interposed between the first continuous sheet of carrier material and the second continuous sheet of carrier material; and,
further comprising the step of: dispensing a greater amount of gel to a central region proximal to the longitudinal axis of the first continuous sheet of carrier material relative to the amount of gel dispensed to a lateral region, distal to the longitudinal axis of the first continuous sheet of carrier material.

According to another aspect of the present invention there is provided a composite aerosol-generating material comprising:
a first sheet of carrier material;
a second sheet of carrier material; and
gel wherein the gel is disposed between the first sheet of carrier material and the second sheet of carrier material, and wherein there is a greater amount of gel disposed on a central region proximal to the longitudinal axis of the first continuous sheet of carrier material relative to the amount of gel disposed on a lateral region, distal to the longitudinal axis of the first continuous sheet of carrier material.

The composite aerosol-generating material of the present invention may be suitable for use in an aerosol-generating rod, or an aerosol generating article. In some embodiments the composite aerosol-generating material is for use in an aerosol-generating rod.

The present invention provides a method of manufacturing a composite aerosol-generating material for use in an aerosol-generating rod, comprising the steps of: providing a first continuous sheet of carrier material; dispensing gel to a surface of the first continuous sheet of carrier material; providing a second continuous sheet of carrier material and positioning the second continuous sheet of carrier material to the gel to form a composite material with gel interposed between the first continuous sheet of carrier material and the second continuous sheet of carrier material. Positioning the first continuous sheet and the second continuous sheet (of carrier material) accurately enables the consistent manufacture of the composite aerosol-generating material.

Preferably, the method of manufacturing a composite aerosol-generating material, further comprises the step of crimping. This may be crimping of the first continuous sheet of carrier material, or the second continuous sheet of carrier material, or both the first and second continuous sheets of carrier material. Crimping provides an ease of manufacture by facilitating the gathering of the sheet in the subsequent manufacturing step, because as a result of the crimping operation, the resilience of the sheet of carrier material is weakened and a plurality of ridges and corrugations are provided on the sheet. The ridges and corrugations are regularly distributed at pre-defined locations and extend substantially over the whole length of the sheet. Thus, crimping helps the gathering of the sheet in a more defined way. In addition, crimping also make possible for a bigger amount of sheet material to be pulled through a funnel shaped device for forming an aerosol-generating rod in comparison to uncrimped sheets. Moreover, crimping helps create the homogeneous distribution of flow channels and maintaining the flow channels by weakening the resilience of the sheet of aerosol-generating material. The rate of crimping and the size and pattern of the grooves or indentations can vary. Thus, a large number of different aerosol flow conditions can be produced for specific desired resistant to draw property. Preferably the crimping step is performed before dispensing of the gel onto the first continuous sheet of carrier material, or on to the surface-portion of the first continuous sheet of carrier material. Crimping before dispensing makes the manufacturing easier than crimping after dispensing of gel. It helps to prevent the gel being squeezed out during crimping and thus to reduce the risk of gel contacting the manufacturing equipment. And crimping before dispensing also advantageously makes it possible to crimp only one of the first or the second sheet of the carrier material, instead of crimping a composite aerosol-generating material comprising at least two sheets of carrier material.

In specific embodiments, the method of manufacturing a composite aerosol-generating material further comprises the step of: providing a first continuous sheet of carrier material and a second continuous sheet of carrier material from different respective sources of carrier material. Having the first continuous sheet of carrier material and the second continuous sheet of carrier material from different sources of carrier materials or being different carrier materials allows a great number of different materials and combinations of the different carrier materials to be used. Thus, various different composite aerosol-generating materials comprising different combinations of carrier materials or aerosol-generating materials (or both different carrier materials and aerosol-generating materials) deliver a great number of different aerosols.

In specific embodiments, the method of manufacturing a composite aerosol-generating material further comprises the step of providing both a first continuous sheet of carrier material and a second continuous sheet of carrier material from a single source of carrier material. This may simplify the manufacturing process by having only one source of carrier material to produce the first and second continuous sheets of carrier material.

In specific embodiments, the method of manufacturing a composite aerosol-generating material further comprises the step of folding a continuous sheet of the single source of carrier material to form both the first continuous sheet of carrier material and the second continuous sheet of carrier material such that the first continuous sheet of carrier material and the second continuous sheet of carrier material are integral with each other via a folding line. Folding a sheet of a source carrier material to form the first and second continuous sheets of carrier material allows ease of manufacture and efficient use of material. It also prevents the dispensed gel from being squeezed out on one side.

The folding of the sheet of the source carrier material may be by any suitable means known in the art, including using guides. Specific embodiments comprise using guides to fold the sheet of the source carrier material. In specific embodiments the guides used with the present invention may be a roller type of guide, for example a directional roller, or a positioning roller; or a static curved surface guide; or any combination of the types of guides mentioned. Movement of the sheet of the source carrier material towards the folding means bends the sheet of source carrier material over on to itself until the folding process is completed and one lateral side section of the continuous sheet of carrier material is folded completely over making contact with the gel already dispensed on the other lateral side section of the sheet of the source carrier material.

In specific embodiments, the method of manufacturing a composite aerosol-generating material further comprises the step of cutting a continuous sheet of a single source of carrier material to form both a first continuous sheet of carrier material and a second continuous sheet of carrier material. Cutting a source carrier material to form a first continuous sheet and a second continuous sheet of carrier material ensures that the material for the first continuous sheet of carrier material and the second continuous sheet of carrier material are the same, for example, in term of composition or thickness. Additionally, by providing both carrier material sheets from a single source, the material properties of the first continuous sheet of carrier material and the second continuous sheet of carrier material will be consistent.

Typically, the width of a carrier material for cutting may be in the range of 5 centimeters to 50 centimeters wide, preferably around 20-40 centimeters wide, more preferably around 25 centimeters wide.

The cutting of the sheet of the source carrier materials will typically use a cutting means, for example a cutter, one or more of a knife or a blade or a saw, or a jig-saw type of cutter, or a circular knife, to give a clean cut of the sheet of the source carrier material to form both a first and second continuous sheet of carrier material. The cutting blade will typically face towards the oncoming source carrier material. Typically, but not necessarily, the cutting means will be an inline system, cutting the source carrier material into two sections along the longitudinal direction of the sheet of the source carrier material. The cutting means may cut the source carrier material into more than two sections depending on the requirements. The first continuous sheet of carrier material and the second continuous sheets of carrier material are formed separated. In embodiments where the second continuous sheet of carrier material will be positioned in contact with the gel, guiding means and transportation means will be required to position the second continuous sheet of carrier material into the desired position, ideally positioned on the gel already dispensed on the first continuous sheet of carrier material. In this way a gel is embedded in a sandwich configuration between the two continuous sheets of carrier material. Typically, the first continuous sheet of carrier material formed from cutting the carrier material continues on the same or similar path and direction as the carrier material being cut. The second continuous sheet of carrier material is guided by the guide means to be positioned in contact with the gel, which has been dispensed on the first continuous sheet of carrier material. Preferably the sheet of carrier material is cut longitudinally in the convey direction of the sheet before gel is dispensed onto the first continuous sheet of carrier material. Cutting the sheet of source carrier material before dispensing the gel reduces the risk of gel contacting the cutting means, for example a cutter. It also reduces the risk of dust from the cutting means contacting the gel or the nozzles of the gel. Preferably there is a distance between the cutting stage and the gel dispensing stage in order to prevent dust generated on the cutting stage from interfering with the gel dispensing. If the aerosol-generating material is cut into more than two sections or sheets of carrier material, each section or sheet may be used or moved away in a similar way as explained for the first or second continuous sheet of carrier material. One cutting means may supply the first continuous sheet of carrier material and the second continuous sheet of carrier material for a number of apparatuses to manufacture composite aerosol-generating material. The composite aerosol-generating material is then gathered together to produce an aerosol-generating rod. The sheet cutting means may have a dust protection means, for example, a vacuum source to collect dust from the cutter. Having a dust protection means may allow a shorter distance between the cutter and the gel application stage and thus a faster production of the composite aerosol-generating material and subsequent aerosol-generating rods. The sequence of cutting and dispensing gel is not essential for implementation of the invention, and in principle each stage of cutting and dispensing gel could happen before, or after the other or at the same time, depending on the embodiment. In some embodiments of the present invention, the gel is dispensed by a gel dispensing means comprising at least one nozzle. Using nozzles aids accurate dispensing of the gel both for the amount of the gel dispensed and for the positioning of the gel dispensed. In some embodiments, in combination with other steps, the method of manufacturing a composite aerosol-generating material further comprises the step of: adjusting the gel output by a control system. A control system may aid to accurately dispense the gel both for the amount of the gel dispensed and for the position of the gel dispensed. The dispensing means of the gel may have a number of nozzles creating a number of gel strips on the first continuous sheet of carrier material. In some embodiments, not all nozzles will dispense gel at the same time. Alternatively, in some embodiments all of the nozzles may dispense gel at the same time. The control system may also record the dispensing of the gel, including both the amount of gel dispensed and the position of gel dispensed, so that the total amount of any ingredient in the gel can be calculated and tracked. The gel dispensing means, for example, a dispenser, may also have a temperature control system to control the temperature of the gel. Ideally, the gel dispensing means comprising a heater or thermic sensor or both. Preferably such systems would also comprise a feedback loop to process the information. The system may make any necessary change, for example, to the heat required or to the dispensing rate of gel. Typically increasing the temperature lowers the viscosity of the gel and it would be easier or quicker to dispense. Some gels may require temperatures for optimal dispensing and storage. Having the gel at the required temperature before reaching the nozzles may aid consistent dispensing of the gel. The heater may be a resistance heater, although any suitable heater may be used. The dispensing means, for example a dispenser, may also comprise a cooling means, for example a cooler. The cooling means may aid setting of the gel, once the gel is in the correct position. And thus, the risk of leakage is reduced. Alternatively, or in addition, the cooling means, depending on the type of gel used, may aid holding the first and second continuous sheets of carrier material together. In some examples, the cooling means decreases the viscosity of the gel so that it remains in the same position once set. In other examples, the cooling means speeds up the setting of the gel. The gel dispensing means may also comprise one or more of: flowmeters, pumps and actuated faucets, allowing fine adjustments to the flow of gel being dispensed. This has the advantage of being able to make fine adjustments to keep the gel flow consistent. This is important as the gel may change over time during the manufacture process. Many factors, for example, humidity and ambient temperature, as well as different variants in the supplied gel may lead a change on the gel. In preferred embodiments each nozzle has a flowmeter and an actuated faucet allowing independent adjustment of the flow of gel dispensing from the nozzle. In some embodiments the nozzles used to dispense gel onto the first continuous sheet of carrier material dispenses the same type of gel on each sheet of carrier material. Alternatively, the nozzles dispensing gel onto the first continuous sheet of carrier material may dispense different types of gel. For example, in some embodiments when the nozzles dispense different types of gel, one or more nozzles may dispense a flavor containing gel. Alternatively, one or more nozzles may dispense a nicotine containing gel. Alternatively, one or more nozzles may dispense a glycerin containing gel. Alternatively, one or more nozzles may dispense a propylene glycol containing gel. Alternatively, one or more nozzles may dispense any combination of the types of gel mentioned. Having different nozzles for different types of gel allows fine adjustment and varying adjustments of the ingredient of the gel. For example, more flavor may be required for a different final product, or a particular ingredient is preferred in a particular position on the sheet of aerosol-generating material.

In preferred embodiments the gel dispensing means dispenses gel on the same side of the first continuous sheet of carrier material. Preferably this is the top side of the sheet so that due to the gravity, the dispensed gel may readily rest and be secured on the sheet of carrier material for transportation to the subsequent manufacturing step.

In some embodiments, the method of manufacturing a composite aerosol-generating material further comprises the step of non-uniformly dispensing gel to one surface of a first continuous sheet of carrier material.

In some embodiments, the method of manufacturing a composite aerosol-generating material further comprises the step of dispensing a greater amount of gel to a central region proximal to the longitudinal axis of a first continuous sheet of carrier material relative to the amount of gel dispensed to a lateral region, distal to the longitudinal axis of the first continuous sheet of carrier material.

In some embodiments the method of manufacturing a composite aerosol-generating material, further comprises the step of dispensing at least 10 percent more gel mass to the central region proximal to the longitudinal axis of a first continuous sheet of carrier material relative to the mass dispensed to a lateral region distal to the longitudinal axis of the first continuous sheet of carrier material. Alternatively, the method may comprise the step of dispensing at least 15 percent more gel mass to the central region. In other embodiments, the method comprises dispensed at least 20 percent more gel mass to the central region, or at least 25 percent more gel mass to the central region.

Controlling the amount of gel and the gel position on the first or second continuous sheet of carrier material or in the composite aerosol-generating material may reduce the risk of leakage of the gel from the composite aerosol-generating material. The avoidance of gel leakage may also assist in a uniform manufacture of the composite aerosol-generating material and thus ensure the performance uniformity on the final manufactured products.

In certain embodiments, the method of manufacturing of a composite aerosol-generating material further comprises the step of providing a continuous band of susceptor material. Preferably the method of manufacturing of a composite aerosol-generating material comprises positioning the continuous band of susceptor material to the gel. Preferably the continuous band of susceptor material is positioned to the gel after the gel is dispensed onto a first continuous sheet of carrier material. In certain embodiments the composite aerosol-generating material comprises a susceptor material. The susceptor material allows heating by induction heating. When the susceptor material is located in an electromagnetic field, eddy currents are induced, and hysteresis losses occur in the susceptor material causing heating of the susceptor material. In embodiments where the susceptor material is located in thermal contact or close thermal proximity with the aerosol-generating material or the gel, the aerosol-generating material or gel is heated. On heating the aerosol-generating material or gel may assist in the release or generation of aerosols. Preferably, the susceptor material is in direct physical contact with the gel. Although in alternative embodiments the susceptor material may be positioned between sheets of carrier material without direct physical contacting with gel.

The susceptor may be formed from any material that can be inductively heated to a temperature sufficient to generate or release an aerosol, for example, from the gel or aerosol-generating material, or carrier material carrying an aerosol-generating substrate, or gel. In some embodiments the susceptor comprises carbon. A preferred susceptor may comprise or consist of a ferromagnetic material, for example a ferromagnetic alloy, ferritic iron, or a ferromagnetic steel or stainless steel. A preferred susceptor materials comprise metal, for example, aluminium. Preferred susceptors may be heated to a temperature in excess of 50 degrees Celsius. More preferably susceptors may be heated to a temperature between about 40 degree Celsius and about 500 degree Celsius, in particular between about 50 degree Celsius and about 450 degree Celsius, preferably between about 100 degree Celsius and about 400 degree Celsius. The susceptor may also comprise a non-metallic core with a metal layer disposed on the non-metallic core, for example metallic tracks formed on a surface of a ceramic core.

The susceptor may comprise a protective external layer, for example a protective ceramic layer or protective glass layer encapsulating the susceptor. The susceptor may comprise a protective coating formed by a glass, a ceramic, or an inert metal, formed over a core of susceptor material.

The susceptor may be a multi-material susceptor. In particular, the susceptor may comprise a first susceptor material and a second susceptor material. The first susceptor material preferably is optimized with regard to heat loss and thus heating efficiency. For example, the first susceptor material may be aluminum, or a ferrous material such as a stainless steel. In contrast, the second susceptor material preferably is used as temperature marker. For this, the second susceptor material is chosen such as to have a Curie temperature corresponding to a predefined heating temperature of the susceptor assembly. At its Curie temperature, the magnetic properties of the second susceptor change from ferromagnetic to paramagnetic, accompanied by a temporary change of its electrical resistance. Thus, by monitoring a corresponding change of the electrical current absorbed by the induction source it can be detected when the second susceptor material has reached its Curie temperature and, thus, when the predefined heating temperature has been reached. The second susceptor material preferably has a Curie temperature that is below the ignition point of the aerosol-forming substrate, that is, preferably lower than 500 degree Celsius. Suitable materials for the second susceptor material may include nickel and certain nickel alloys. Nickel has a Curie temperature in the range of about 354 degree Celsius to 360 degree Celsius depending on the nature of impurities. A Curie temperature in this range is ideal because it is approximately the same as the temperature that the susceptor should be heated to in order to generate an aerosol from an aerosol-forming substrate, but still low enough to avoid local overheating or burning of the aerosol-forming substrate.

If the susceptor has the form of a strip, in particular a blade, a plate, a sheet, a band, or a foil, the susceptor preferably has a substantially rectangular cross-section. In this case, the susceptor preferably has a width dimension that is greater than a thickness dimension, for example greater than twice a thickness dimension. Advantageously, a strip-shaped susceptor has a width preferably between about 2 millimeters and about 8 millimeters, more preferably, between about 3 millimeters and about 5 millimeters, and a thickness preferably between about 0.03 millimeters and about 0.15 millimeters, more preferably between about 0.05 millimeters and about 0.09 millimeters.

In specific embodiments, the method of manufacturing a composite aerosol-generating material further comprises the steps of repeating the steps of manufacturing a composite aerosol-generating material and layering the composite aerosol-generating material one on top of the other. The composite aerosol-generating material may therefore comprise multiple layers, creating a multi-layered composite aerosol-generating material. The respective component layers of the composite aerosol-generating material may be same or different in respect of their composition or structure. A number of combinations could be made using different composite aerosol-generating materials, and additionally, in some embodiments, different carrier layers, to make up the final composite aerosol-generating material. This allows many different composite aerosol-generating materials to be manufactured, potentially with many different aerosol qualities and characteristics. In specific embodiments the method of manufacturing a composite aerosol-generating material comprises the step of layering one composite aerosol-generating material on top of another composite aerosol-generating material. In certain embodiments the method of manufacturing a composite aerosol-generating material comprises the steps of layering one composite aerosol-generating material on top of another and inserting a susceptor material between the two layers of composite aerosol-generating material. The composite aerosol-generating materials or multi-layered composite material can be gathered up and preferably wrapped to form a composite aerosol-generating rod.

In specific embodiments, the apparatus or method of manufacture further comprises a layering system. The layering system is able to layer composite aerosol-generating materials preferably one on top of the other. The description and given examples only exemplarily refer to a vertical orientation of top and bottom with composite aerosol-generating materials on top of one another, but other embodiments with other orientations having the composite aerosol-generating material next to each other may work and are included in the scope of the disclosure herein. In preferred embodiments the composite aerosol-generating materials are stacked such that the top and bottom surfaces of the stacking layers of the composite aerosol-generating materials are without gel. In these specific embodiments the outer facing sides of the individual composite aerosol-generating materials are preferably without gel.

In some embodiments the susceptor is positioned between layers of composite aerosol-generating material. In embodiments where there is no gel between layers of composite aerosol-generating material (meaning no gel on the outside surfaces of the composite aerosol-generating) and a susceptor is positioned between the outer sides of layers of composite aerosol-generating material, then the susceptor may not be adjacent to gel. However, the susceptor may still be able to heat the gel through the layers of composite aerosol-generating material. Advantageously, having the susceptor between the outer surfaces of the composite aerosol-generating material is easy to manufacture. In alternative embodiments gel may be positioned or dispensed on the outer surface of the layers of composite aerosol-generating material and thus in these embodiments the susceptor is adjacent to gel, when a susceptor is positioned between the outer surfaces of composite aerosol-generating material.

Other embodiments may have gel between the composite aerosol-generating material, but ideally would be without gel on outer surfaces that are not next to another composite aerosol-generating material. Preferably the gel is only on inner surfaces and thus any outer surfaces are without gel. Advantageously, this avoids gel contamination by reducing the risk of gel making contact with the wrapping material, or contacting surfaces in the machinery, such as guide means, for example a guide, for positioning the sheet and the funnel-shaped device for gathering the sheet into a continuous cylindrical rod.

In specific embodiments, the layering system comprises at least one lateral moving system. Such lateral moving system may move one material, for example, one sheet of carrier material or a composite aerosol-generating material from a side to above (or below) or parallel to another material, for example another sheet of carrier material or composite aerosol-generating material. The manufacturing process, or apparatus, or layering system may have a number of lateral moving systems. Typically, the number of lateral moving systems in an apparatus, or a layering system or a manufacturing process is equal to the number of sections minus one. Ideally each lateral moving system takes care of one different source section. For instance, if the carrier material is cut into two parts to form the first sheet of carrier material and the second continuous sheet of carrier material there is one lateral moving system moving one sheet, for example, the second continuous sheet of carrier material above (or below) the other. Preferably the lateral moving system(s) put all the materials, for example, sheets of carrier material composite aerosol-generating material, in a vertical pile, one above another. As explained other orientations in other embodiments are possible.

In some preferred embodiments the method of manufacturing a composite aerosol-generating material further comprises the step of pressing the composite aerosol-generating material in a direction perpendicular to its planar surface. In a vertical stack of layers of composite aerosol-generating material, for example, the pressure from the pressing system is exerted along the height of the stack. Different pressure can be exerted on the stack of material. The pressing system may have a changeable pressure force exertion depending on the desired effect or the size of stacked materials. In specific embodiments, the apparatus for manufacture or the manufacturing system comprises two pressing rollers that work together to exert a pressure force when a composite aerosol-generating material is passed through the rollers. In specific embodiments the apparatus for manufacture or the manufacturing system comprises one pressing roller. Ideally the pressure of the pressing system is high enough for the material to adhere to the gel strips but low enough not to cause structural damage on the sheet. Ideally the gel strips are not pressed to a point where there is no air path between the continuous sheets of carrier material or the layers of composite aerosol-generating material.

The present invention further provides a composite aerosol-generating material comprising: a first sheet of carrier material; a second sheet of carrier; and gel wherein the gel is disposed between the first sheet of carrier material and the second sheet of carrier material.

In preferred embodiments, the composite aerosol-generating material further comprises a susceptor material positioned between the first sheet of carrier material and the second sheet of carrier material. The susceptor material allows heating by induction heating. When the susceptor material is located in an electromagnetic field, eddy currents are induced, and hysteresis losses occur in the susceptor material causing heating of the susceptor material.

In the manufacture of the composite aerosol-generating material, the first sheet of carrier material and the second sheet of carrier material are preferably continuous sheets. However, the continuous sheets may be cut to specific length as required, and thus no longer continuous.

In preferred embodiments the gel comprises one or more of a flavour, an active agent, a plasticizer, a humectant, nicotine, glycerine, or propylene glycol.

In preferred embodiments the sheet of carrier material comprises tobacco material.

The present invention also relates to a composite aerosol-generating rod comprising a composite aerosol-generating material as herein described or as manufactured by the steps as herein described.

An apparatus for manufacturing a composite aerosol-generating material for use in an aerosol-generating rod comprising: means to supply a first continuous sheet of carrier material; means to dispense gel to a surface of the first continuous sheet of carrier material; a layering system for providing and positioning a second continuous sheet of carrier material to the gel to form a composite aerosol-generating material.

An example of a means to supply is a supply apparatus.

In specific embodiments, in combination with other features, the apparatus further comprises a cutter located upstream of the layering system to cut a sheet of a source carrier material along the longitudinal axis of the sheet of the source carrier material to form the first continuous sheet of carrier material and the second continuous sheet of carrier material.

In specific embodiments, in combination with other features the apparatus further comprises a folding means, for example, a folder, adapted to fold at least a portion of a sheet of a source carrier material along the longitudinal axis of the sheet of the source carrier material to form the first continuous sheet of carrier material and the second continuous sheet of carrier material.

In specific embodiments, in combination with other features, the apparatus further comprises a crimping system. Preferably the crimping system is positioned upstream of the gel dispensing and layering system.

The first continuous sheet of carrier material, or the second continuous sheet of carrier material, or both the first and second continuous sheets of carrier material, may be crimped. Where the composite aerosol-generating material is multi-layered any combination of crimped and non-crimped sheets of carrier material may be used to make up the multi-layered composite aerosol-generating material.

The present invention also discloses an apparatus that further comprises a layering means configured to layer the composite materials to form a multi-layered composite aerosol-generating material. This could be layering the same composite aerosol-generating material upon itself or layering different composite aerosol-generating material one on top of another. An example of a layering means is an apparatus for layering.

In specific embodiments the apparatus further comprises a pressing system, wherein the composite aerosol-generating material or multi-layered composite aerosol-generating material, or both, is pressed by at least one pressing roller. In preferred embodiments the apparatus further comprises a means for gathering the composite aerosol-generating material or the multi-layered composite aerosol-generating material, or both. In preferred embodiments the apparatus further comprises a means for wrapping the composite aerosol-generating material or multilayered composite aerosol-generating material, after it has been gathered. The wrapping means enables the composite aerosol-generating material to be cut into aerosol-generating rods. In some embodiments the apparatus comprises a cutter to cut the continuous length of wrapped composite aerosol-generating material to desired lengths. Thus, the wrapped composite aerosol-generating material can be transported easily in the process of manufacture. The apparatus of the present invention may comprise any feature as described herein for the manufacturing of the composite aerosol-generating material, for example the gel dispensing means, nozzles, control means, guides, rollers, pressing system or any combination thereof.

In specific embodiments the sheet of carrier material comprises porous material. In specific embodiments the sheet of carrier material may consist of porous material. The porous material has the advantage that the material can hold the gel securely. Advantageously a carrier material that is porous may securely hold the gel to a greater extent than a non-porous carrier material. The pores of a porous material are able to absorb the gel and therefore lead the gel easily rested and quickly adhered on the sheet of porous carrier material. The porous material can strongly secure gel on the surface of the carrier sheet by absorption through its pores. Thus, a porous material can prevent movement of the gel adjacent to the porous material. The porous material used in the present invention assists in reducing leakages of gel from the composite aerosol-generating material. Composite aerosol-generating material made from porous assists in reducing leakages of gel, thus reduces contamination of machinery parts during production, for example, reducing the contamination of the cutting blade of a cutter, when the continuous length of wrapped composite aerosol-generating material is to be cut into desired lengths.

The porous material may be any suitable porous material able to hold or retain the gel. Ideally the porous material can allow the gel to move within it. In specific embodiments the porous material comprises natural materials, synthetic, or semi-synthetic, or a combination of the mentioned materials. In specific embodiments the porous material, comprises sheet material, foam, or fibres, for example loose fibres; or a combination thereof. In specific embodiments the porous material, comprises a woven, non-woven, or extruded material, or combinations thereof. Preferably the porous material, comprises, for example, cotton, paper, viscose, PLA, or cellulose acetate, of combinations thereof. Preferably the porous material comprises a sheet material, for example, cotton or cellulose acetate. Advantages of a porous material is that the gel is retained within the porous material, and this may aid manufacturing, storage or transport of the gel. It may assist in keeping the desired shape of the gel, especially during manufacture, transport, or use. The porous material used in the present invention may be crimped or shredded. In specific embodiments the porous material comprises crimped porous material.

In some embodiments the gel is at least partly absorbed into the porous material. In a sandwich arrangement of the present invention using two porous carrier materials has the advantage that two porous materials are holding the gel in place thus giving improved or greater securing of the gel, in comparison to using only one porous material. Thus, using two porous material in a sandwich type arrangement according to the present invention is advantageous to offer improved retention of gel. Improved retention of gel allows improved control of dispensing the gel and less waste, due to less movement of gel and leakage. The gel can be accurately positioned with reduced movement or loss of the gel and the additives or materials in the gel. Thus, improved control of dosage of gel and additives in the gel can be achieved. Less leakage of gel also gives less contamination of machinery and therefore less down-time in production to clean or repair machinery.

In specific embodiments the carrier material comprises an aerosol-generating material. The carrier material may comprise for example, tobacco, tobacco material, powder tobacco, tobacco stems, nicotine, tobacco leaf or cast leaf tobacco, or any combination of the mentioned aerosol-generating materials. An aerosol-generating material may also be a porous material with advantageous of holding gel. In specific embodiments the carrier material may comprise an aerosol-generating material and the gel may also comprise an aerosol-generating substrate. In alternative embodiments either the gel or the carrier material may comprise an aerosol-generating substrate.

In combination with specific embodiments the gel comprises a gelling agent. In specific embodiments the gel comprises agar or agarose or sodium alginate or Gellan gum, or a mixture thereof.

In specific embodiments the gel comprises water, for example, the gel is a hydrogel. Alternatively, in specific embodiments the gel is non-aqueous.

Preferably the gel comprises an active agent. In combination with specific embodiments the active agent comprises nicotine. In specific embodiments, the nicotine is included in the gel with an aerosol-former for the desired nicotine delivery. Locking the nicotine into a gel at room temperature is desirable to prevent leakage.

In specific embodiments, the gel comprises a solid tobacco material that releases flavour compounds when heated. Depending on the specific embodiments the solid tobacco material is, for example, one or more of: powder, granules, pellets, shreds, spaghettis, strips or sheets containing one or more of: plant material, such as herb leaf, tobacco leaf, fragments of tobacco ribs, reconstituted tobacco, homogenised tobacco, extruded tobacco and expanded tobacco.

The gel may include any suitable gelling agent. For example, the gelling agent may include one or more biopolymers, such as two or three biopolymers. Preferably, where the gel includes more than one biopolymer, the biopolymers are present in substantially equal weights. The biopolymers may be formed of polysaccharides. Biopolymers suitable as gelling agents include, for example, gellan gums (native, low acyl gellan gum, high acyl gellan gums with low acyl gellan gum being preferred), xanthan gum, alginates (alginic acid), agar, guar gum, and the like. Preferably, the gel comprises agar. Preferably the gel only comprises a single gelling agent. Preferably, this single gelling agent is agar or guar.

As used herein, the term “aerosol-generating article” is used to describe an article able to generate, or release, an aerosol.

As used herein, the term “aerosol-generating device” is a device to be used with an aerosol-generating article to enable the generation of an aerosol, typically from the aerosol-generating article. Often the aerosol-generating device will comprise a heater.

As used herein, the term “aerosol-generating material” is used to describe a material that assists in, or is capable, of generating an aerosol, for example, cast tobacco leaf. The term also includes a material that assists in the release of aerosols from an aerosol-generating substrate, such as an aerosol former.

As used herein, the term “aerosol-generating substrate” is used to describe a substrate that is capable of generating an aerosol, for example cast leaf tobacco or nicotine.

As used herein, the term “carrier material” is used to describe a material that assists in, or is capable, of carrying, storing or supporting an element. In the present invention this includes carrying a gel. Especially when the gel comprises an aerosol-generating substrate. The term “carrier” also includes an aerosol-generating material, tobacco, cotton, or any material that can carry an aerosol-generating substance, for example a gel. For example, the aerosol-generating material can absorb the gel and/or is not destroyed by the gel.

As used herein, the term “composite aerosol-generating material” is used to describe a material comprising two or more elements, wherein at least one element comprises an aerosol-generating substrate or aerosol-generating material. The composite aerosol-generating material need not have two or all elements to be aerosol-generating.

As used herein, the term “crimped” denotes a material having a plurality of substantially parallel ridges or corrugations. It also includes the process of making a material crimped. The ridges may be longitudinal, transverse, angular, straight, waved, continuous, interrupted or any combination thereof. Longitudinal ridges are preferred as they will improve the formation of flow channels extending over substantially whole length of the sheet once the sheet is gathered. Moreover, in comparison to uncrimped or otherwise crimped sheets, the longitudinal ridges formed by crimping will also help obtain aa homogeneous distribution of flow channels on a cross section of the formed aerosol-generating rod, because crimping helps air flow channel formed at pre-defined location and ensures that each air flow channel has a relatively similar cross section size. Therefore, a relatively consistent resistance to draw (RTD) for the aerosol-generating rod can be achieved.

For purposes of the present disclosure, as used herein the term “diameter” or “width” is a maximum transverse dimension of the composite aerosol-generating material or first and second continuous sheets of carrier material, a portion or a part thereof, the aerosol-generating article or aerosol-generating device. By way of example, the “diameter” is a diameter of an object having a circular transverse section or is the length of the diagonal width of an objection having a rectangular cross section.

As used herein, the term “gathered” is used to describe a sheet that is convoluted, folded, or otherwise compressed or constricted substantially transversely to the longitudinal axis of the composite aerosol-generating material; or first or second continuous sheets of carrier material; or composite aerosol-generating material.

As used herein, the term “gel” is used to describe a solid jelly-like semi-rigid material or mixture of materials, with a three-dimensional network able to hold other materials and capable of releasing materials into an aerosol.

As used herein, the term “longitudinal” is used to describe the direction between the downstream or proximal end and opposed upstream or distal end of the aerosol-generating article or the aerosol-generating material; or the composite aerosol-generating material; or the sheets of carrier material

As used herein, the term “outer” with reference to the sheet of carrier material, is used to describe a portion that is more towards the longitudinal sides of the sheet of carrier material than the middle of the cross-section portion of the sheet of carrier material. Similarly, the term “inner” or “central” is used to describe (with reference to the sheets of carrier material), a portion of the material that is more central of the cross-section portion, than near to the longitudinal sides of the sheets of carrier material.

As used herein, the term “plasticizer” is used to describe a substance, typically a solvent, added to produce or promote plasticity or flexibility, and to reduce brittleness.

As used herein the term “rod” is used to describe a component, segment or element, for use in an aerosol-generating article. A “continuous rod” is a precursor to a rod, before cutting to a desired length.

The term “porous material” as used herein, is used to describe any material capable of holding, retaining or supporting gel. Typically, the porous medium will have passages within its structure that can be filled to retain or hold fluid or semi-solids for example to retain gel. Preferably the gel will also be able to pass, or transfer, along and through the passages within the porous material (to some degree).

As used herein, the term “susceptor” is used to describe an element comprising a material that is capable of being inductively heated within an alternating electromagnetic field. This may be the result of at least one of hysteresis losses and eddy currents induced in the susceptor, depending on the electrical and magnetic properties of the susceptor material. Hysteresis losses occur in ferromagnetic or ferrimagnetic susceptors due to magnetic domains within the material being switched under the influence of an alternating electromagnetic field. Eddy currents may be induced if the susceptor is electrically conductive. In case of an electrically conductive ferromagnetic susceptor or an electrically conductive ferrimagnetic susceptor, heat can be generated due to both, eddy currents and hysteresis losses. Accordingly, the susceptor may comprise a material which is at least one of electrically conductive and magnetic.

As used herein, the term “Resistance to Draw” (RTD), is used to describe the resistance for fluid, for example gas, to be drawn through a material. As used herein, resistance to draw is expressed and is measured in accordance with ISO 6565:2002.

As used herein the term “sheet” or “sheet material” is used to describe a generally planar, laminar element in which its width and length are substantially greater than its thickness.

Any of the features or steps described herein in relation to one embodiment, aspect or example, of the composite aerosol-generating material, multi-layered composite aerosol-generating material or the aerosol-generating rod or the manufacture (including the apparatus) thereof of any, may be equally applicable to any other embodiment, aspect or example of any of the composite aerosol-generating material, multi-layered composite aerosol-generating material, the aerosol-generating article or the aerosol-generating rod, their method of manufacture or the apparatus to manufacture.

### EXAMPLES

Ex1. A method of manufacturing a composite aerosol-generating material for use in an aerosol-generating rod, comprising the steps of:
   providing a first continuous sheet of carrier material;
   dispensing gel to a surface of the first continuous sheet of carrier material;
      providing a second continuous sheet of carrier material and positioning the second continuous sheet of carrier material to the gel to form a composite material with gel interposed between the first continuous sheet of carrier material and the second continuous sheet of carrier material.
Ex2. The method of manufacturing a composite aerosol-generating material according to example Ex1, further comprising the step of: crimping, at least one of; the first continuous sheet of carrier material and the second continuous sheet of carrier material.
Ex3. The method of manufacturing a composite aerosol-generating material according to example Ex1 or Ex2, further comprising the step of: providing the first continuous sheet of carrier material and the second continuous sheet of carrier material from different respective sources of carrier material.
Ex4. The method of manufacturing a composite aerosol-generating material according to example Ex1 or Ex2, further comprising the step of: providing both the first continuous sheet of carrier material and the second continuous sheet of carrier material from a single source of carrier material.
Ex5. The method of manufacturing a composite aerosol-generating material according to example Ex4, further comprising the step of: folding a continuous sheet of the single source of carrier material to form both the first continuous sheet of carrier material and the second continuous sheet of carrier material such that the first continuous sheet of carrier material and the second continuous sheet of carrier are integral with each other via a folding line.
Ex6. The method of manufacturing a composite carrier material according to example Ex4, further comprising the step of: cutting a continuous sheet of the single source of carrier material to form both the first continuous sheet of carrier material and the second continuous sheet of carrier material.
Ex7. The method of manufacturing a composite aerosol-generating material according to any example Ex1 to Ex6, further comprising the step of: dispensing a greater amount of gel to a central region proximal to the longitudinal axis of the first continuous sheet of carrier material relative to the amount of gel dispensed to a lateral region, distal to the longitudinal axis of the first continuous sheet of carrier material.
Ex8. The method of manufacturing of a composite aerosol-generating material according to any example Ex1 to Ex7, further comprises the step of providing a continuous band of susceptor material and positioning the continuous band of susceptor material to the gel after the gel is dispensed onto the first continuous sheet of carrier material.
Ex9. The method of manufacturing a composite aerosol-generating material according to any example Ex1 to Ex8, further comprising the step of pressing the composite aerosol-generating material in a direction perpendicular to its planar surface.
Ex10. The method of manufacturing a composite aerosol-generating material according to any example Ex1 to Ex9, wherein the gel comprises a flavour or an active agent or a plasticizer or a humectant or nicotine or glycerine or propylene glycol or any combination thereof.
Ex11. The method of manufacturing a composite aerosol-generating material according to any example Ex1 to Ex10, wherein the composite aerosol-generating material comprises tobacco material.
Ex12. A composite aerosol-generating material comprising:
a first sheet of carrier material;
a second sheet of carrier material; and
gel wherein the gel is disposed between the first sheet of carrier material and the second sheet of carrier material.
Ex13. A composite aerosol-generating material according to example Ex12 further comprises a susceptor material positioned between the first sheet of carrier material and the second sheet of carrier material.
Ex14. A composite aerosol-generating material according to example Ex12 or Ex13, wherein the first continuous sheet of carrier material, or the second sheet of carrier material, or both the first and second sheets of carrier material, comprise an aerosol-generating material.
Ex15. A composite aerosol-generating rod comprising: a composite aerosol-generating material according to examples Ex12 to Ex14; or comprising a composite aerosol-generating material as manufactured according to any of examples Ex1 to Ex11.

Reference will now be made to the drawings, which depict one or more aspects described in this disclosure. However, it will be understood that other aspects not depicted in the drawings fall within the scope of this disclosure. Like numbers used in the figures refer to like components, steps and the like. However, it will be understood that the use of a number to refer to a component in a given figure is not intended to limit the component in another figure labeled with the same number. In addition, the use of different numbers to refer to components in different figures is not intended to indicate that the different numbered components cannot be the same or similar to other numbered components. The figures are presented for purposes of illustration and not limitation. Schematic drawings presented in the figures are not necessarily to scale.

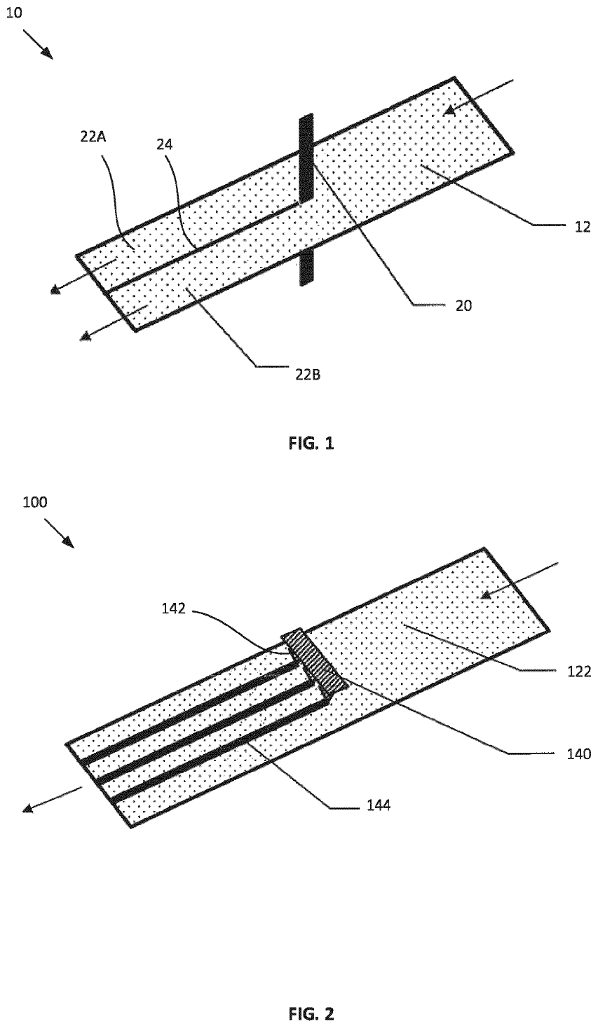

FIG. 1 is a schematic perspective view of a cutting system for cutting a sheet of source carrier material.

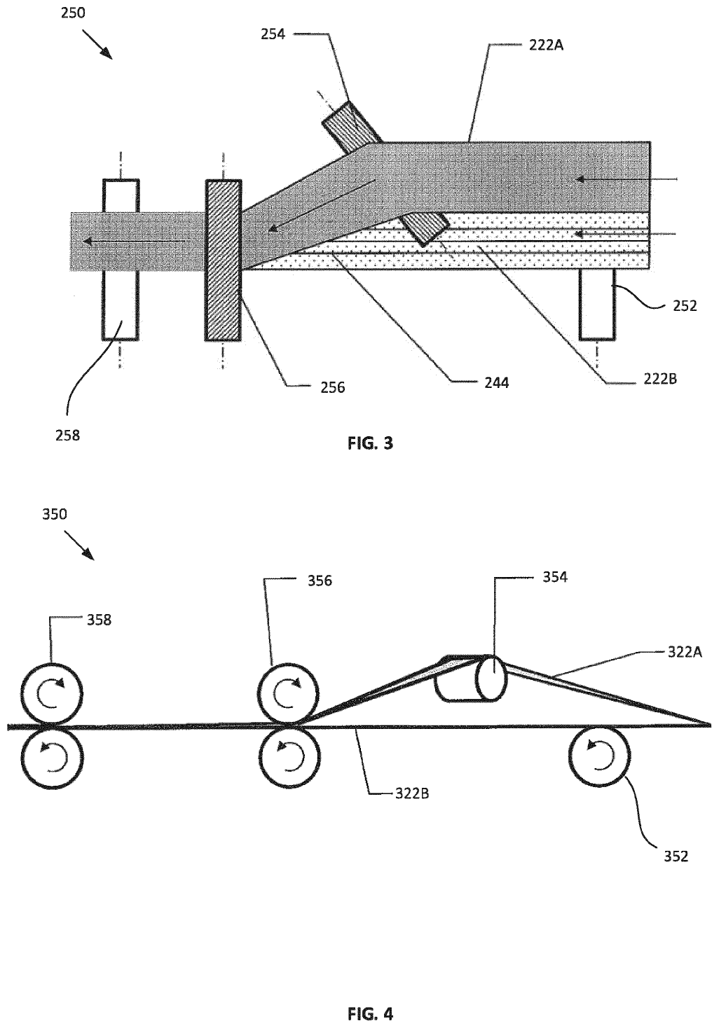

FIG. 2 is a schematic perspective view of example of a gel dispensing system with several nozzles for a sheet of source carrier material.

FIG. 3 illustrates a schematic top view of a layering system for manufacturing an aerosol-generating material stack.

FIG. 4 illustrates a schematic side view of the layering system of FIG. 3.

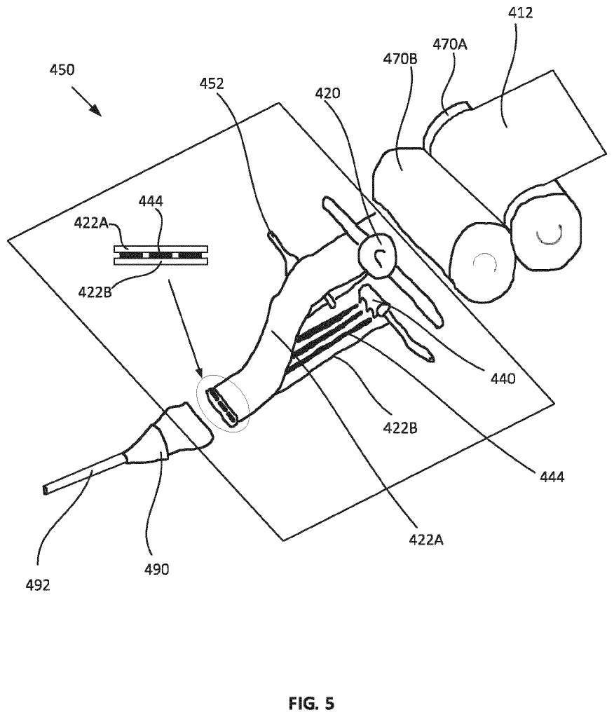

FIG. 5 is a schematic perspective view of a system for manufacturing an aerosol-generating rod.

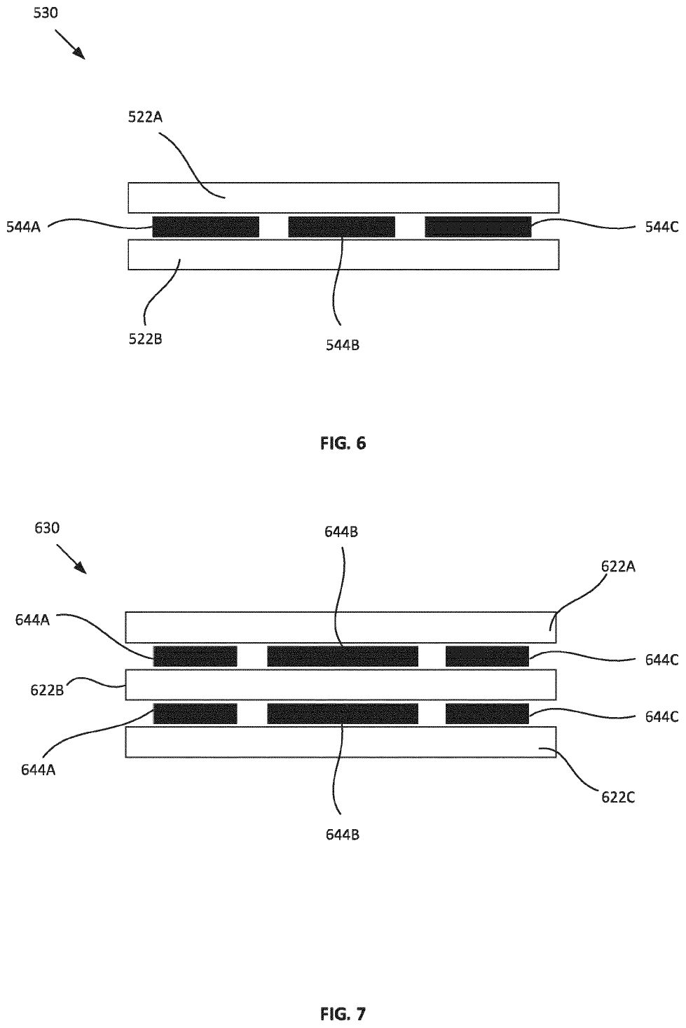

FIG. 6 is a schematic cross-sectional view of a composite aerosol-generating material according to an embodiment.

FIG. 7 is a schematic cross-sectional view of a composite aerosol-generating material according to another embodiment.

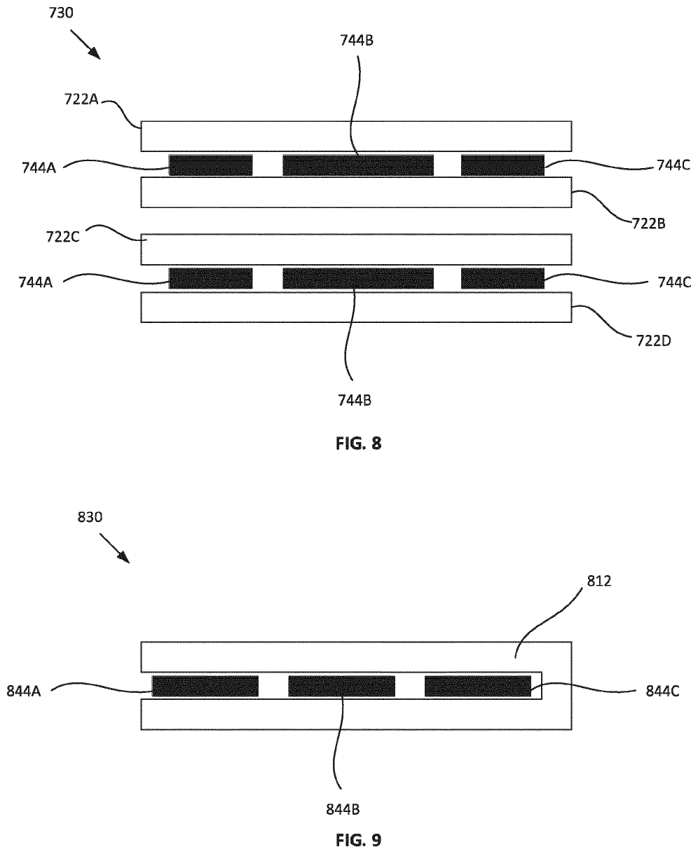

FIG. 8 is a schematic cross-sectional view of a composite aerosol-generating material according to a further embodiment.

FIG. 9 is a schematic cross-sectional view of a composite aerosol-generating material according to a further embodiment.

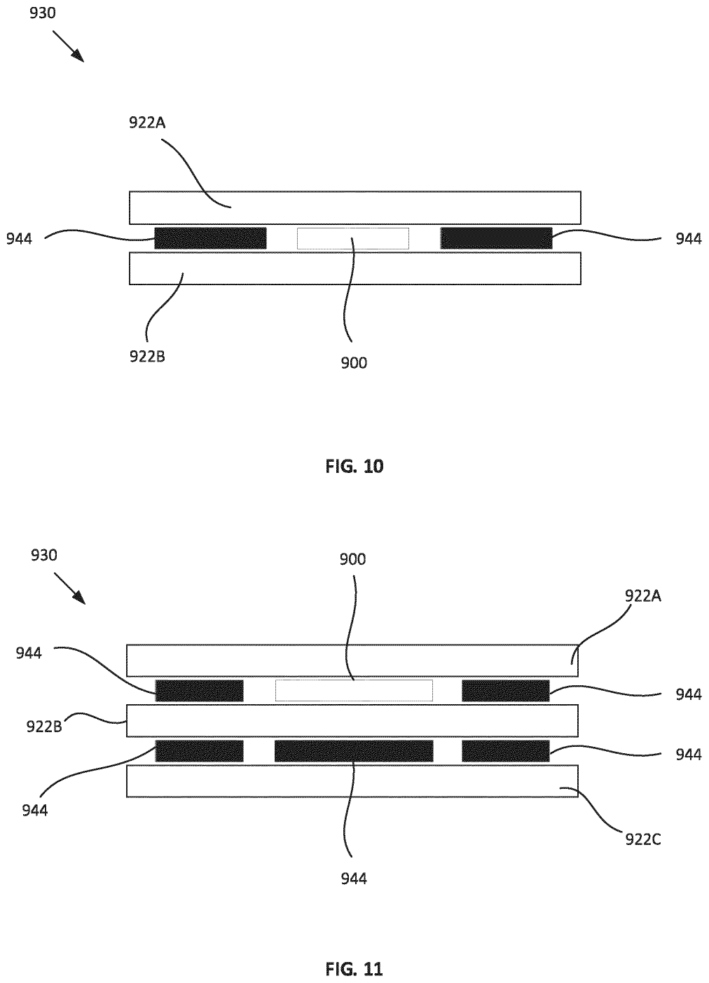

FIG. 10 is a schematic cross-sectional view of a composite aerosol-generating material comprising a susceptor material according to an embodiment.

FIG. 11 is schematic cross-sectional view of a composite aerosol-generating material comprising a susceptor material according to a further embodiment.

FIG. 12 is a schematic drawing of a cross-sectional view of a susceptor between two composite aerosol-generating materials.

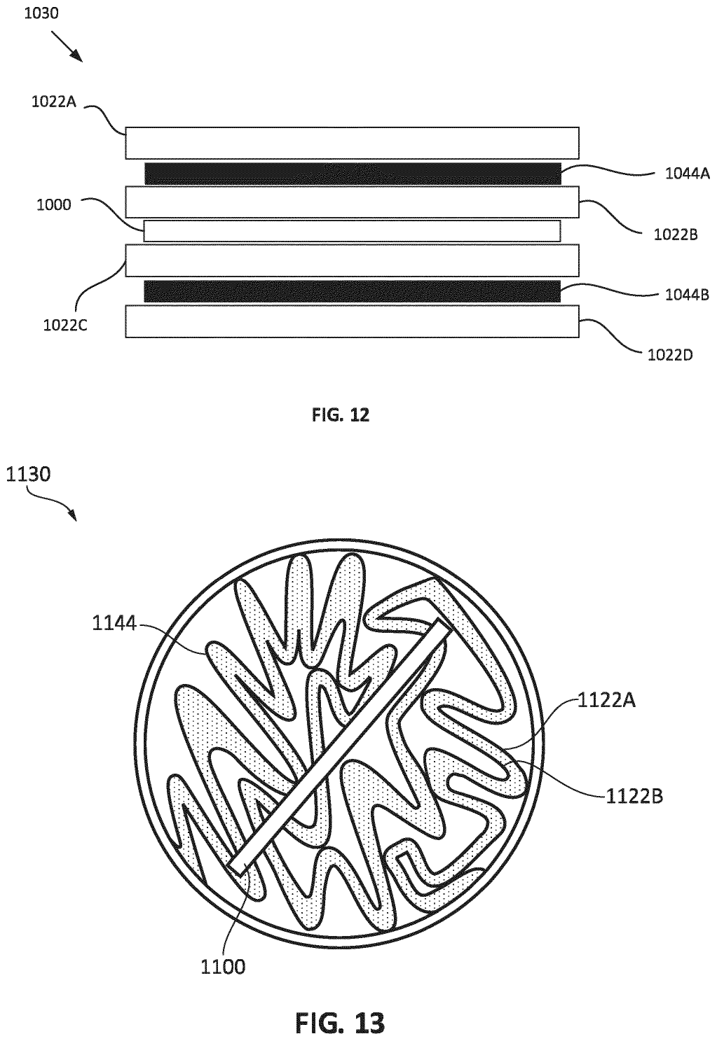

FIG. 13 is a cross-section view of an aerosol-generating rod where a susceptor is positioned between composite aerosol-generating materials before gathering.

FIG. 1 illustrates an example of a cutting system 10. A source sheet of carrier material 12 is initially unwound from a bobbin (not shown) and is transported in a direction generally indicated by the arrows. The source sheet of carrier material 12 has a longitudinal axis in the longitudinal direction and has a specified width and a specified thickness. In specific embodiments, the source carrier material 12 is preferably tobacco cast leaf (TCL), but in other embodiments, the source carrier material 12 comprise other materials, for example cotton. The cutting system 10 preferably comprises a cutter 20 which in this example takes the form of an inline knife 10. In certain embodiments, other cutters 20 are used, for example a circular knife or a rotary cutter.

The inline knife 20 has a longitudinal axis perpendicular to the longitudinal axis of the sheet of source carrier material 12 so that the sharp edges of the knife 20 points towards the incoming sheet of source carrier material 12. The sheet of source carrier material 12 is cut by the knife 20 into two sections 22A, 22B along the cutting line 24. In certain embodiments, the sheet of source carrier material 12 is cut along its longitudinal axis such that both the first section 22A and the second section 22B have the same width. In other embodiments, the sheet of source carrier material 12 is cut along a cutting line 24 offset from the longitudinal axis so that the first section 22A has a greater width relative to the second section 22B, or so that the second section 22B has a greater width relative to the first section 22A. In other examples, the sheet of source carrier material 12 is cut into more than two sections 22A, 22B, for example using more than one cutter 20, or using the same cutter 20. The cutting process typically produces dust, so in some embodiments, the cutting system 10 also comprises dust protection in the cutting system 10. For example, the dust protection takes the form of an air aspiration system (not shown) so that the dust produced is at least partially evacuated in a controller manner. By including dust protection, a higher proportion of dust is prevented from contacting the gel 144 (see FIG. 2) or the source carrier material 12, which would otherwise cause contamination and quality issues. The two sections 22A, 22B form the first and second continuous sheets of carrier material.

FIG. 2 illustrates an example of a gel dispensing system 100. The gel dispensing system 100 comprises a gel dispensing station 140 having three gel dispensing nozzles 142. Each nozzle 142 dispenses a gel 144 onto a surface-portion of the section 122 of a first continuous sheet 12 of carrier material. Three gel strips 144 are applied to the section 122 of the first continuous sheet of carrier material. The section 122 of the first continuous sheet of carrier material is transported along a direction generally indicated by the arrows in this example. In certain embodiments, a different number of gel dispensing stations 140 or nozzles 142 are employed. In such embodiments, a different number of gel strips 144 are produced. In this example, the gel strips 144 dispensed from the nozzles 142 are preferably parallel to one another, but in other examples, the gel strips 144 are non-parallel to one another, for example, wavy, offset or in loops along the longitudinal direction of the section 122 of the first continuous sheet of carrier material.

In some examples, the quantity of gel 144 applied per strip and per dispensing system is computed so that during the layering process and the pressing process (both as will be described), the gel 144 does not spread beyond the surface of the section 122 of the first continuous sheet of carrier material. This prevents the gel 144 from contacting (and therefore contaminating) the inner surface of the funnel shaped device 490 (see FIG. 5) during gathering or the pressing process or wrapping process (not shown).

In some examples, the gel dispensing system 100 includes a temperature control system (not shown) having a heater (not shown) and thermic sensor (not shown) coupled through a feedback loop. The temperature control system heats up the gel 144 and controls its temperature to remain within a target range of temperatures before reaching the gel dispensing station(s) 140. Optionally, the gel dispenser station 140 additionally comprises, such as, flowmeters, pumps or actuated faucets (not shown) which allow the flow of each nozzle 142 to be independently adjustable, or alternatively or in addition, which allow the type of gel 144 to be delivered by different nozzles 142, for example on different positions of section 122 of the first continuous sheet of carrier. This is particularly advantageous because it facilitates different amounts of gel 144 to be applied, and thus facilitates different composite aerosol-generating materials to be manufactured. The amount of gel 144 dispensed can be varied by altering, for example the flow rate of the nozzle or the length of time the gel 144 is dispensed from the nozzle. In certain embodiments, the variation of the amount of gel 144 can be altered for each nozzle independently. This also enables the flow of gel 144 from each nozzle 142 to be adjusted depending on the position of the nozzle 142, for example a nozzle 142 located near the longitudinal axis of the section 122 of the first continuous sheet of carrier material is adapted to dispense a greater amount of gel 144 relative to the amount dispensed by a nozzle 142 near the edges of the section 122 of the first continuous sheet of carrier material in order to prevent the spread of gel 144 beyond the surface of the section 122 of the first continuous carrier material during the pressing process. The flow rate of gel 144 dispensed, the duration of time gel 144 is dispensed, or the pattern formed by the gel 144 dispensed is altered in different examples. It should be appreciated that the sequence of the cutting step (of the source carrier material 12) and the gel application step is not relevant. The cutting step of the source carrier material 12 preferably takes place before the gel dispensing step, but in certain embodiments, the cutting step takes place after the gel dispensing step, or at the same time as the gel application step.

FIGS. 3-4 depict an embodiment of a layering system 250, 350 for manufacturing an aerosol-generating rod. The layering system 250, 350 places two sections 222A, 222B, a first continuous sheet of carrier material 222B and a second continuous sheet of carrier material 222A, on top of each other to form a composite aerosol-generating material 530 (as is better shown in FIG. 6). Each of the first and second continuous sheets of carrier material 222B, 222A have a specified width. Each of the first and second continuous sheets of carrier materials 222B, 222A has a specified thickness. The composite aerosol-generating material 530 comprises the first and second continuous sheets of carrier material 222B, 222A and a gel 244 interposed between the first and second continuous sheets of carrier material 222B, 222A. The layering system 250, 350 comprises a lateral moving system which places a second continuous sheet of carrier material 222A onto a first continuous sheet of carrier material 222B. In this example, the second continuous sheet of carrier material 222A is on the top and the first sheet continuous of carrier material 222B is on the bottom. In other embodiments, the composite aerosol-generating material 530 is configured in other ways, for example the second continuous sheet of carrier material 222A is placed beneath the first continuous sheet of carrier material 222B. The lateral moving system places the first and second continuous sheets of carrier material 222B, 222A into a vertical pile, one above the other such that the second continuous sheet of carrier material 222A is exactly above and parallel to the first continuous sheet of carrier material 222B. In other embodiments, the second continuous sheet of carrier material 222A and the first continuous sheet of carrier material 222B are offset from one another. The layering system 250, 350 depicted in FIGS. 3-4 illustrates one lateral moving system for placing the first and second continuous sheets of carrier material 222B, 222A on top of one another. In other embodiments the layering system 250, 350 comprises multiple lateral moving systems, enabling a stack of more than two sheets of carrier materials 222A, 222B to be manufactured. In the example illustrated in FIGS. 3-4, the first continuous sheet of carrier material 222B and the second continuous sheet of carrier material 222A are unwound from separate bobbins (not shown) onto the lateral moving system of the layering system 250, 350, but in other embodiments, a single sheet of source carrier material 222 is unwound from a bobbin, and then cut into separate sections, the first continuous sheet of carrier material 222B and the second continuous sheet of carrier material 222A. Rollers 252, 254, 256, and 258 assist in directing the first continuous sheet of carrier material or the second continuous sheet of carrier material, or both the first and second continuous sheets of carrier material.

As best seen in FIG. 4, the lateral moving system comprises a conveying roller 352, a directional roller 354 and a pair of positioning rollers 356. The first continuous sheet of carrier material 322B is transported on the conveying roller 352. The second continuous sheet of carrier material 322A is contacted by a directional roller 354 from a side which has not received gel 344 to avoid contamination. The directional roller 354 is angled so that the movement of the second continuous sheet of carrier material 322A is redirected towards the first continuous sheet of carrier material 322B. The angle of the directional roller 354 is chosen so that manufacturing space is saved, while not applying too high a strain onto the second continuous sheet of carrier material 322A which would otherwise cause the structure of the second continuous sheet of carrier material 322A to be altered. Both the second continuous sheet of carrier material 322A and the first continuous sheet of carrier material 322B are then directed through the positioning rollers 356 which is placed at a location where the second continuous sheet of carrier material 322A is disposed adjacent the first continuous sheet of carrier material 322B. The distance from the first continuous sheet of carrier material 322B to the surface of the positioning roller 356 is approximately equal to the thickness of the second continuous sheet of carrier material 322A. This arrangement allows the two continuous sheets of carrier material 322B,322A, to contact when they pass through the positioning rollers 356. The rotational axis of the positioning rollers 356 is perpendicular to the transporting direction of the first sheet of aerosol-generating material 322B. This aligns the second continuous sheet of carrier material 322A to the first continuous sheet of carrier material 322B, as is seen from FIG. 3.

In certain embodiments, the layering system also includes a pressing system having two pressing rollers 358 where the second continuous sheet of carrier material 322A and the first continuous sheet of carrier material 322B additionally pass through. When the first and second continuous sheets of carrier material 322B, 322A are transported through the pressing rollers 358, the pressure applied by the pressing rollers 358 allows the second continuous sheet of carrier material 322A, the first continuous sheet of carrier material 322B and the interposing gel 344 to adhere together. The pressure is computed to be high enough to facilitate adhesion of the first and second continuous sheets of carrier material 322B, 322A and gel 344, but low enough so that the first and second continuous sheets of carrier material 322B, 322A are not structurally damaged, and further so that the gel strips 344 are not pressed to a point where there is no air path between the first and second continuous sheets of carrier material 322B, 322A. In such instance, the first and second continuous sheets of carrier material 322B, 322A with gel 344 would create an air tight block without aerosol or air flowing through, which in some instances would affect resistance to draw properties. In certain embodiments, the positioning rollers 356 take the form of a single positioning roller acting on a surface. In certain embodiments the pressing rollers 358 take the form of a single pressing roller acting on a surface.

FIG. 5 depicts an embodiment of a layering system 450 for manufacturing an aerosol-generating rod. A tobacco cast leaf (TCL) sheet 412 (an example of a source carrier material being an aerosol-generating material as well) is unwound from a bobbin (not shown) and crimped by a pair of crimping rollers 470A, 470B, creating ridges and grooves in the sheet of source carrier material 412. The crimped sheet 412 of source carrier material is then cut into two sections, forming the first and second continuous sheets of carrier material 422B, 422A by a cutter 420. The cutter 420 in this example is an inline cutter and more specifically a circular knife. It should be envisaged that the step of crimping is optional. In certain embodiments, the step of cutting is replaced by providing the first and second continuous sheets of carrier material 422B, 422A from different bobbins or sources. The cutting step is provided so that storage space required for multiple bobbins of the first and second continuous sheets of carrier material 422B, 422A is reduced. A gel 444 is applied by a gel dispensing system 440 having three nozzles 442 that each dispenses a gel strip 444 onto a surface of the first continuous sheet of carrier material 422B. The second continuous sheet of carrier material 422A is directed by a redirecting fork 452 towards the gel dispensed surface of the first continuous sheet of carrier material 422B to form a composite aerosol-generating material or “sandwich” having the first and second continuous sheets of carrier material 422B, 422A, with a gel 444 disposed between the first and second continuous sheets of carrier material 422B, 422A. A cross-sectional detailed view of the composite aerosol-generating material is shown in FIG. 5, where three gel strips 444 of approximately equal width are disposed between the second continuous sheet of carrier material 422A and the first continuous sheet of carrier material 422B. The composite aerosol-generating material of the first and second continuous sheets of carrier material 422B, 422A with gel 444 at its core is then directed towards an input end of a funnel 490, where it is to be compressed into a continuous rod 492 shape at the output end of the funnel 490.

FIG. 6 depicts a schematic cross-sectional view of a composite aerosol-generating material 530 according to an embodiment. The composite aerosol-generating material 530 includes a first sheet of carrier material 522B and a second sheet of carrier material 522A. Three gel strips 544 are disposed between the first sheet of carrier material 522B and the second sheet of carrier material 522A. A central gel strip 544B is located in a central region proximal to the longitudinal axis, and gel strips 544A, 544C are spaced apart in a lateral region on either side of the central gel strip 544B. In this embodiment, the gel strips 544A, 544B, 544C have the same width. Thus, it can be said that the gel strips 544A, 544B, 544C are disposed uniformly. Gel strips 544A, 544C are preferably positioned inward from the outer edges of the first and second sheets of carrier material 522B, 522A to avoid the smear of gel on the machinery, for example avoid contamination of the funnel (not shown) by the leakage of gel 544. In other embodiments, gel strips 544 are dispensed non-uniformly (see FIG. 7). The composite aerosol-generating material 530 is produced using the layering system 450 as described hereinbefore with reference to FIG. 5. In certain embodiments, the first continuous sheet of carrier material 522B and the second continuous sheet of carrier material 522A are provided from the same sheet 512, for example, on a single bobbin (not shown), and then cut into two to form the first and second continuous sheets of carrier material 522B, 522A via the cutting system 420. In other embodiments, the first continuous sheet of carrier material 522B and second continuous sheet of carrier material 522A are each provided from a different source, for example, the first continuous sheet of carrier material 522B is provided on a first bobbin (not shown) and the second continuous sheet of carrier material 522A is provided on a different bobbin (not shown).

FIG. 7 depicts a schematic cross-sectional view of a composite aerosol-generating material 630 according to another embodiment. The composite aerosol-generating material 630 includes a first sheet of carrier material 622B, a second sheet of carrier material 622A and a third sheet of carrier material 622C. Three gel strips 644 are disposed between the first sheet of carrier materials 622B and the second sheet of carrier material 622A. A central gel strip 644B is located in a central region proximal to the longitudinal axis, and gel 644A, 644C are spaced apart in a lateral region on either side of the central gel strip 644B. In this embodiment, another further three gel strips 644 are disposed between the first sheet of carrier material 622B and the third carrier material 622C. The gel strips 644B in the central region have a greater width that the gel strips 644A, 644B in the lateral region. Thus, it can be said that the gel strips 644A, 644B, 644C are disposed non-uniformly. In other examples, the distribution of gel 644A, 644B, 644C between the first sheet of carrier material 622B and the second sheet of carrier material 622A is different from the distribution of gel 644A, 644B, 644C between the first sheet of carrier material 622B and the third sheet of carrier material 622C. In some examples, gel 644 is uniformly distributed between the first sheet of carrier material 622B and the second sheet of carrier material 622A, and gel 644 is non-uniformly distributed between the first sheet of carrier material 622B and the third sheet of carrier material 622C. Gel strips 644A, 644C are preferably positioned inward from the outer edges of the first and second sheets of carrier material 622B, 622A to avoid contamination of the machinery by the smear of gel, for example gel 644 leakage into the funnel (not shown). Specifically, in this example, more gel 644 is dispensed in the central region proximal to the longitudinal axis of the second sheet of carrier material 622A relative to the amount of gel 644 dispensed in a lateral region distal to the longitudinal axis of the second sheet of carrier material 622A. Thus, the central gel strip 644B has a greater width than the gel strips 644A, 644C. This reduces the risk of contamination, for example gel 644 leakage into the funnel (not shown). In specific embodiments, 10 percent (%) more gel 644 mass is dispensed in the central region relative to the lateral region. In other embodiments, 20 percent (%) more gel 644 mass is dispensed in the central region relative to the lateral region of a sheet of aerosol-generating material.

The composite aerosol-generating material 630 is produced using the layering system 450 as described hereinbefore with reference to FIG. 5. In specific embodiments, preferably the first, second and third sheets of carrier material 622B, 622A, 622C are provided from the same source of carrier material, for example, on a single bobbin (not shown), and then cut into three sections 622A, 622B, 622C via the cutting system 420. In specific embodiments, the gel 644 is placed on both sides of the first continuous sheet of carrier material 622B, and the second and third continuous sheets 622A, 622C of carrier material are placed on to the first sheet of carrier material 622B via the layering system 450. In certain embodiments, the composite aerosol-generating material 630 is constructed by providing the first and third continuous sheets of carrier material 622B, 622C and applying gel strips 644 on top of each of the first and third continuous sheets of carrier material 622B, 622C. The first continuous sheet of carrier material 622B is placed on the third continuous sheet of carrier material 622C and then the second continuous sheet of carrier material 622A is placed on top of first continuous sheet of carrier material 622B. Preferably, the top and bottom surfaces of the composite aerosol-generating material 630 do not have gel 644. In certain embodiments, two of the three—first, second or third continuous sheets of carrier material 622A, 622B, 622C are provided from the same source of carrier material, for example, on a single bobbin (not shown), and cut into two sections via the cutting system 420. In specific embodiments, each of the first, second and third continuous sheets of carrier material 622A, 622B, 622C are each provided from a different source. Namely, the sheets 622A, 622B, 622C are unwound from different respective bobbins. In alternative embodiments, the manufacture of the composite aerosol-generating material involves repeating the steps of manufacturing a composite aerosol-generating material and layering the composite aerosol-generating material one on top of the other. This provides a composite aerosol-generating material with additional layers and/or a different number of layers.

The composite aerosol-generating material 630 is manufactured by an apparatus (not shown) having a means to supply a first continuous sheet of carrier material 622A. In one embodiment, the means to supply the first continuous sheet of carrier material 622A is a bobbin (not shown). The apparatus has a nozzle that dispenses gel 644 onto the surface of the first continuous sheet of carrier material 622A, and a layering system that provides and positions a second continuous sheet of carrier material 622B onto the gel 644 to form a composite aerosol-generating material 630. In another embodiment, the first continuous sheet of carrier material 622A is supplied by a cutter. The cutter is located upstream of the layering system. The cutter cuts the sheet of a source of carrier material along its longitudinal axis to form the first continuous sheet of carrier material 622A and the second continuous sheet of carrier material 622B. Additionally, in some examples, the apparatus further comprises a folding means that folds a portion of a sheet of source carrier material along its longitudinal axis to form the first continuous sheet of carrier material 622A and the second continuous sheet of carrier material 622B.

FIG. 8 depicts a schematic cross-sectional view of a composite aerosol-generating material 730 according to a further embodiment. The composite aerosol-generating material 730 includes a first sheet of carrier material 722A, a second sheet of carrier material 722B, a third sheet of carrier material 722C and a fourth sheet of carrier material 722D. Three gel strips 744 are disposed between the first sheet of carrier material 722A and the second sheet of carrier material 722B. A central gel strip 744B is located in a central region proximal to the longitudinal axis, and gel strips 744A, 744C are spaced apart in a lateral region on either side of the central gel strip 744B. In this embodiment, no gel is disposed between the second sheet of carrier material 722B and the third sheet of carrier material 722C. Instead, another further three gel strips 744 are disposed between the third sheet of carrier material 722C and the fourth sheet of carrier material 722D. The composite aerosol-generating material 730 comprises two composite aerosol-generating materials, 722A, 722B and 722C, 722D. The gel strips 744B in the central region have a greater width than the gel strips 744A, 744C in the lateral region. Thus, it can be said that the gel strips 744A, 744B, 744C are disposed non-uniformly. Gel strips 744A, 744C are preferably positioned inward from the outer edges of the first, second, third and fourth sheets of carrier material 722A, 722B, 722C, 722D to avoid contamination of machinery, for example gel 744 leakage into the funnel (not shown). Specifically, in this example, more gel 744 dispensed in the central region proximal to the longitudinal axis of the section 722 relative to the amount of gel 744 dispensed in a lateral region distal to the longitudinal axis of the section 722. Thus, the central gel strip 744B has a greater width than the gel strips 744A, 744C. This reduces the risk of contamination, for example gel 744 leakage into the funnel (not shown).

The composite aerosol-generating material 730 is produced using the layering system 450 as described hereinbefore with reference to FIG. 5. In specific embodiments, preferably a single sheet is provided from a single source, for example, on a single bobbin (not shown), and then cut into four sections to form the first, second, third and fourth continuous sheets of carrier materials 722A, 722B, 722C, 722D via the cutting system 420. Preferably, the top and bottom surfaces of the composite aerosol-generating material 730 do not have gel 744. In certain embodiments, at least two of the first, second, third or fourth continuous sheets of carrier material 722A, 722B, 722C, 722D are provided from the same sheet of source carrier material, for example, on a single bobbin (not shown), and then cut into two sections via the cutting system 420. In specific embodiments, each of the first, second, third and fourth continuous sheets of carrier material 722A, 722B, 722C, 722D are each provided from a different source. Namely, the sheets 722A, 722B, 722C, 722D are unwound from different respective bobbins.

FIG. 9 depicts a schematic cross-sectional view of a composite aerosol-generating material 830 according to a further embodiment. In this embodiment, gel 844 is deposited on the sheet 812 (a carrier material) and then the sheet 812 is folded back onto itself. As illustrated, this stops gel 844 from being squeezed out from one side. The folding of the sheet 830 creates two layers, the first and second continuous sheets of carrier material which are operatively coupled or integrated with one another. The two layers, the first and second continuous sheets of carrier material are connected by a folding line (not shown).

FIG. 10 depicts a schematic cross-sectional view of a composite aerosol-generating material 930 according to an embodiment. The composite aerosol-generating material 930 includes a first sheet of carrier material 922B and a second sheet of carrier material 922A. Two gel strips 944 are disposed between the first sheet of carrier material 922B and the second sheet of carrier material 922A. A centrally positioned susceptor material 900 is located in a central region proximal to the longitudinal axis, and gel strips 944 are spaced apart in a lateral region either side of the centrally positioned susceptor material 900. In this embodiment the gel strips 944 have the same width. The gel strips 944 are preferably positioned inward from the outer edges of the first carrier material 922B and second carrier material 922A, to avoid gel leakage from the composite aerosol-generating material 930. The composite aerosol-generating material 930 is produced using the layering system 450 as described herein with reference to FIG. 5, with an additional susceptor material 900 insertion mechanism. In the FIG. 10 embodiment the first continuous sheet of carrier material 922B and the second continuous sheet of carrier material 922A are provided from the same sheet 512, for example, from a single bobbin (not shown) and then cut into two, to form the first continuous sheet of carrier material and the second continuous sheet of carrier material. In the manufacturing of the FIG. 10 embodiment the susceptor material 900 is inserted onto the first continuous sheet of carrier material 922B before dispensing of the gel to a surface of the first continuous sheet of carrier material 922B. The susceptor material 900 is shown not in direct contact with the gel strips 944. However, the FIG. 10 embodiment is shown before the composition aerosol-generating material 930 has been pressed. Once pressed the gel strips 944 may spread laterally between the first carrier material 922B and the second carrier material 922A to be in direct contact with the susceptor material 900.

FIG. 11 depicts a schematic cross-sectional view of a composite aerosol-generating material 930 according to another embodiment. The composite aerosol-generating material 930 includes a first sheet of carrier material 922B, a second sheet of carrier material 922A, and a third sheet of carrier material 922C. Two gel strips 944 are disposed between the first sheet of carrier material 922B and the second sheet of carrier materials 922A. A centrally positioned susceptor material 900 is located in a central region proximal to the longitudinal axis of the composite aerosol-generating material 930, and between the two gel strips 944. In this embodiment, another further three gel strips 944 are disposed between the first sheet of carrier material 922B and the third carrier material 922C. Preferably when the composite aerosol-generating material 930 of the FIG. 11 example is pressed the susceptor material 900 may be in direct contact with the gel 944.

FIG. 12 depicts a schematic side view of a composite aerosol-generating material 1030 comprising two layers of composite aerosol-generating materials. The first composite aerosol-generating material comprises two continuous sheets of carrier materials 1022A and 1022B, with gel 1044A between the two continuous carrier materials 1022A and 1022B. The second aerosol-generating material comprises two continuous sheets of carrier material 1022C and 1022D, with gel 1044B between the two carrier materials 1022C and 1022D. Between the two layers of composite aerosol-generating materials is positioned a susceptor or continuous band of susceptor 1000. In this illustrated embodiment the susceptor 1000 is not in direct contact with the gel 1044A, 1044B. In use the heat from the susceptor 1000 or the continuous band of susceptor 100 can still reach the gel though the carrier materials 1022B and 1022C. In this embodiment the carrier materials are all cotton. The gel comprises nicotine. The band of susceptor is aluminium.

FIG. 13 depicts cross-section view along the longitudinal axis of an aerosol-generating rod 1130. Like the FIG. 12 embodiment the band of susceptor 1100 was not positioned adjacent gel 1144, 1044A, 1044B, between continuous carrier materials 1122A and 1122B. In the FIG. 13 embodiment continuous band of susceptor 1100 is placed between composite aerosol-generating material just before gathering the composite aerosol-generating material and the continuous band of susceptor 1100. The gathered material is wrapped to produce a continuous aerosol-generating rod 1130. In this, FIG. 13 embodiment the carrier materials are linen. The band of susceptor is carbon. The gel comprises nicotine. The gel further comprises glycerin.

All scientific and technical terms used herein have meanings commonly used in the art unless otherwise specified. The definitions provided herein are to facilitate understanding of certain terms used frequently herein.

As used in this specification and the appended claims, the singular forms “a”, “an”, and “the” encompass embodiments having plural referents, unless the content clearly dictates otherwise.

As used in this specification and the appended claims, the term “or” is generally employed in its sense including, alternatively or in addition, unless the content clearly dictates otherwise.

As used herein, “have”, “having”, “include”, “including”, “comprise”, “comprising” or the like are used in their open-ended sense, and generally mean “including, but not limited to”. It will be understood that “consisting essentially of”, “consisting of”, and the like are subsumed in “comprising,” and the like.

The words “preferred” and “preferably” refer to embodiments of the invention that may afford certain benefits under certain circumstances. However, other embodiments may also be preferred under the same or other circumstances. Furthermore, the recitation of one or more preferred embodiments does not imply that other embodiments are not useful, and, is not intended to exclude other embodiments from the scope of the disclosure, including the claims.

Any direction referred to herein, such as “top,” “bottom,” “left,” “right,” “upper,” “lower,” and other directions or orientations are described herein for clarity and brevity are not intended to be limiting of an actual device or system. Devices and systems described herein may be used in a number of directions and orientations.

The embodiments exemplified above are not limiting. Other embodiments consistent with the embodiments described above will be apparent to those skilled in the art.

1. A method of manufacturing a composite aerosol-generating material, comprising the steps of:
providing a first continuous sheet of carrier material;
dispensing gel to a surface of the first continuous sheet of carrier material;
providing a second continuous sheet of carrier material and positioning the second continuous sheet of carrier material to the gel to form a composite material with gel interposed between the first continuous sheet of carrier material and the second continuous sheet of carrier material; and,
further comprising the step of: dispensing a greater amount of gel to a central region proximal to the longitudinal axis of the first continuous sheet of carrier material relative to the amount of gel dispensed to a lateral region, distal to the longitudinal axis of the first continuous sheet of carrier material.

2. The method of manufacturing a composite aerosol-generating material according to claim 1, further comprising the step of: crimping, at least one of; the first continuous sheet of carrier material and the second continuous sheet of carrier material.

3. The method of manufacturing a composite aerosol-generating material according to claim 1, further comprising the step of: providing the first continuous sheet of carrier material and the second continuous sheet of carrier material from different respective sources of carrier material.

4. The method of manufacturing a composite aerosol-generating material according to claim 1, further comprising the step of: providing both the first continuous sheet of carrier material and the second continuous sheet of carrier material from a single source of carrier material.

5. The method of manufacturing a composite aerosol-generating material according to claim 4, further comprising the step of: folding a continuous sheet of the single source of carrier material to form both the first continuous sheet of carrier material and the second continuous sheet of carrier material such that the first continuous sheet of carrier material and the second continuous sheet of carrier are integral with each other via a folding line.

6. The method of manufacturing a composite carrier material according to claim 4, further comprising the step of: cutting a continuous sheet of the single source of carrier material to form both the first continuous sheet of carrier material and the second continuous sheet of carrier material.

7. The method of manufacturing of a composite aerosol-generating material according to claim 1, further comprises the step of providing a continuous band of susceptor material and positioning the continuous band of susceptor material to the gel after the gel is dispensed onto the first continuous sheet of carrier material.

8. The method of manufacturing a composite aerosol-generating material according to claim 1, further comprising the step of pressing the composite aerosol-generating material in a direction perpendicular to its planar surface.

9. The method of manufacturing a composite aerosol-generating material according to claim 1, wherein the gel comprises a flavour or an active agent or a plasticizer or a humectant or nicotine or glycerine or propylene glycol or any combination thereof.

10. The method of manufacturing a composite aerosol-generating material according to claim 1, wherein the composite aerosol-generating material comprises tobacco material.

11. A composite aerosol-generating material comprising:
a first sheet of carrier material;
a second sheet of carrier material; and
gel wherein the gel is disposed between the first sheet of carrier material and the second sheet of carrier material, and wherein there is a greater amount of gel disposed on a central region proximal to the longitudinal axis of the first continuous sheet of carrier material relative to the amount of gel disposed on a lateral region, distal to the longitudinal axis of the first continuous sheet of carrier material.

12. A composite aerosol-generating material according to claim 11 further comprises a susceptor material positioned between the first sheet of carrier material and the second sheet of carrier material.

13. A composite aerosol-generating material according to claim 11, wherein the first continuous sheet of carrier material, or the second sheet of carrier material, or both the first and second sheets of carrier material, comprise an aerosol-generating material.

14. A composite aerosol-generating rod comprising: a composite aerosol-generating material according to claim 11.

15. A composite aerosol-generating rod comprising: a composite aerosol-generating material as manufactured according to claim 1.
